(19) United States
(12) Patent Application Publication
(10) Pub. No.: US 2025/0252545 A1
(43) Pub. Date: Aug. 7, 2025

(54) METHODS TO ENFORCE CALIBRATION VIA WEARABLE RECHARGING

(71) Applicant: GOOGLE LLC, Mountain View, CA (US)

(72) Inventors: Charles R. Schabacker, San Jose, CA (US); Philip Brune, Parkland, FL (US); Tyler G. Anderson, San Jose, CA (US); David Manly, Mountain View, CA (US); Quentin Huve, Sunnyvale, CA (US); Bach Nguyen, Coral Springs, FL (US); Bryan J. Justice

(21) Appl. No.: 18/434,361

(22) Filed: Feb. 6, 2024

(51) Int. Cl. G06T 7/00; G01C 9/06; G01C 25/00; G02B 27/01; G06F 3/01; G09G 3/00; H04N 17/00

(52) U.S. Cl. CPC G06T 7/0002; G01C 9/06; G01C 25/00; G02B 27/0172; G06F 3/013; G09G 3/001; H04N 17/002; G01C 2009/066; G02B 2027/011; G02B 2027/0138; G02B 2027/0178; G06T 2207/30168; G09G 2320/043; G09G 2320/0693

(57) ABSTRACT

A deformation detection device detects deformation of a display system, such as a head-mounted display (HMD). The deformation detection device employs one or more sensors configured to detect one or more variations in positional and angular relationships of sensors, displays, and/or other components of the HMD to determine deviations from an original configuration of the HMD. The deformation detection device stores the variations in the positional and angular relationships for subsequent use during a re-calibration process that restores the viewing experience on the HMD.

### BACKGROUND

A head-mounted display (HMD) is a type of display device worn on a head of a user. HMDs provide an immersive display of digital content for virtual reality (VR) applications and/or augmented reality (AR) applications. During manufacture, a factory calibration system configures the HMD intended for distribution to ensure its performance meets general specifications. After the HMD is distributed and received by a user, the HMD is subjected to inelastic mechanical and/or thermo-mechanical deformation during use and/or storage that alters the HMD's disrupts factory-calibrated positional relationships between the HMD components including frame or housing, cameras, sensors, and/or displays. The various mechanisms of inelastic deformation are often collectively referred to as “aging factors” that include wear-and-tear, fatigue from repeated usage, rough handling, dropping, extreme temperature/humidity environments, and/or other sources. These aging factors adversely affect alignment of the HMD components with themselves and/or the user, which negatively impacts how the digital content is perceived by the user. Typically, in order to detect and correct misalignment of the HMD, the HMD includes sensors that operate during use of the HMD. However, conventional sensors only detect elastic ‘as-worn’ deformations that occur on a short timescale and that are directly associated with use. In particular, conventional sensors are unable to detect “aging factors” that affect the HMD even while not in use or occur over a prolonged time scale.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a display system housing a projector system configured to project images toward the eye of a user, in accordance with some embodiments.

FIG. 2 is a diagram of a deformation detection device storing a display system in accordance with some embodiments.

FIG. 3 is a plan view of a deformation detection device including a component layout in accordance with some embodiments.

FIG. 4 is a diagram of a display alignment sensor in accordance with some embodiments.

FIG. 5 is a diagram of an angular position sensor in accordance with some embodiments.

FIG. 6 is a diagram of a camera reference module using a diffractive grating in accordance with some embodiments.

FIG. 7 is a diagram of a camera reference module using pinholes in accordance with some embodiments.

FIG. 8 is a diagram of a camera reference module using a microchart in accordance with some embodiments.

FIG. 9 is a diagram of a camera reference module using a laser array in accordance with some embodiments.

FIG. 10 is a diagram of a mechanical transducer in accordance with some embodiments.

FIG. 11 is a flow diagram illustrating a method for detecting deformation in a display system in accordance with some embodiments.

### DETAILED DESCRIPTION

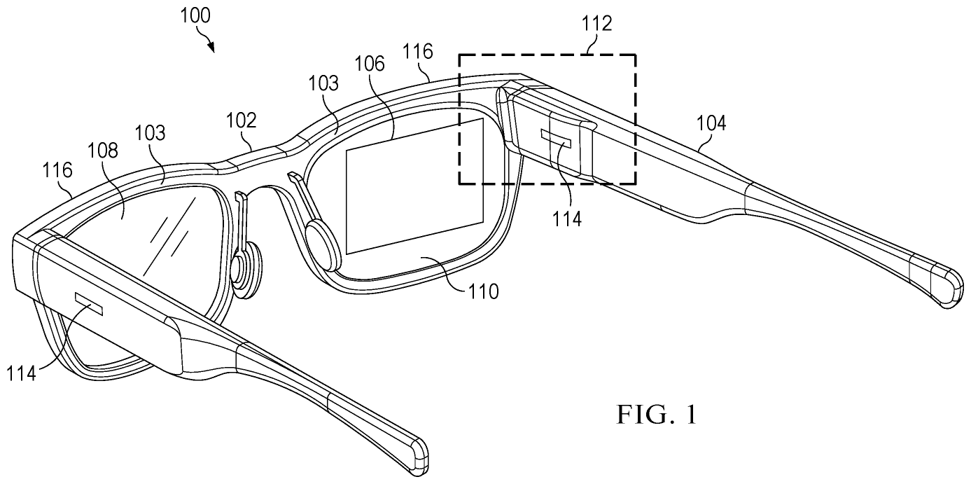

FIGS. 1-11 illustrate systems and techniques for detecting deformation of a display system, such as a head-mounted display (HMD). A deformation detection device employs one or more sensors configured to detect one or more variations in positional and angular relationships of sensors, displays, and/or other components of the HMD. The deformation detection device stores the variations in the positional and angular relationships for subsequent use during a (re-)calibration (e.g., correction) process.

To illustrate via an example, in some embodiments, the deformation detection device is constructed as a portable case to receive the HMD therein. In various embodiments, the deformation detection device is configured to charge the HMD while the HMD remains disposed in the deformation detection device. Additionally, while the HMD is charged in the deformation detection device, the one or more sensors detect the positional and angular relationships at different portions of the HMD to identify any deviations from an original configuration. Thus, in some embodiments, the one or more sensors detect the positional and angular relationships based on the original configuration stored in a processing system, including a processor device and a memory unit.

The original configuration of the HMD is referred to as a default configuration or factory settings. Specifically, the original configuration of the HMD is determined by a manufacturer for proper operation of the HMD during use. For example, the HMD has a frame, a light engine, a display in a lens, and/or other components constructed and positioned to provide a relatively good viewing experience for a user. In some embodiments, the HMD provides virtual reality (VR) and/or augmented reality (AR) viewing experiences by projecting images through the display in the lens. However, the VR and/or the AR viewing experience is based on proper positioning of all the components on the HMD. To illustrate, in order for the user to view the digital content, the digital content must be presented from the display in the lens at a particular position with respect to the user. A misalignment of the lens changes the position of the digital content and correspondingly, changes the viewing experience for the user because the digital content appears at a different location with respect to the original configuration. As another example, a misalignment (e.g., warping, bending) of the frame adjusts how the frame rests on a head of the user due to different angular positioning of the frame, such that the frame is considered “crooked”. Accordingly, the viewing experience is negatively impacted.

To maintain a relatively good viewing experience, the deformation detection device calibrates the HMD based on the level of deformation detected by the one or more sensors of the HMD. In different embodiments, the deformation detection device detects the level of deformation, stores, and transmits the deformation information to an external device for calibration. The deformation detection device calibrates the HMD by adjusting the configuration of one or more components of the HMD corresponding to the one or more components detected as deviated from the original configuration. For example, the deformation detection device corrects a deformed (e.g., warped) lens by adjusting output of the images from the display to a different angle such that the viewing experience for the user is similar to the original configuration in response to the one or more sensors detecting the deformed lens causes the images to change position relative to the original configuration, and therefore, appear differently to the user. Accordingly, the deformation detection device is responsive to any detected changes that affect the HMD and restores the viewing experience for the user.

FIG. 1 illustrates a display system 100 having a frame 102 that includes a first arm 104, which houses a projection system configured to project display light representative of images toward an eye of a user, such that the user perceives the projected images as being displayed in a field of view (FOV) area 106 of a display at a first lens 108 and/or a second lens 110. In the depicted embodiment, the display system 100 is an HMD that includes the frame 102 configured to be worn on the head of a user and has a general shape and appearance of a pair of eyeglasses. The frame 102 contains or otherwise includes various components to facilitate the projection of such images toward the eye of the user, such as a plurality of light engines 114, a plurality of projectors, a plurality of optical scanners, and a plurality of waveguides 116. In some embodiments, the frame 102 further includes various sensors, such as one or more front-facing cameras, rear-facing cameras, world cameras, eye-tracking cameras, other light sensors, motion sensors, accelerometers, inertial mass units, and the like. The frame 102 further can include one or more radio frequency (RF) interfaces or other wireless interfaces, such as a Bluetooth® interface, a Wi-Fi interface, and the like. Further, in some embodiments, the frame 102 further includes one or more batteries or other portable power sources for supplying power to the electrical components of the display system 100. In some embodiments, some or all of these components of the display system 100 are fully or partially contained within an inner volume of the frame 102, such as within the arm 104 in a region 112 of the frame 102. It should be noted that while an example form factor is depicted, it will be appreciated that in other embodiments the display system 100 may have a different shape and appearance from the eyeglasses frame depicted in FIG. 1.

The first lens 108 and/or the second lens 110 are used by the display system 100 to provide an augmented reality (AR) display in which rendered digital content can be superimposed over or otherwise provided in conjunction with a real-world view as perceived by the user through the first lens 108 and/or the second lens 110. For example, display light used to form a perceptible image or series of images may be projected by a projector of the display system 100 onto the eye of the user via a series of optical elements, such as the plurality of waveguides 116 disposed at least partially within or otherwise connected to the first lens 108 and/or the second lens 110, one or more scan mirrors, and one or more optical relays. Thus, in some embodiments, the first lens 108 and/or the second lens 110 include at least a portion of a waveguide that routes display light received by an incoupler of each waveguide 116 to an outcoupler of each waveguide 116, which outputs the display light toward an eye of a user of the display system 100. The display light is modulated and scanned onto the eye of the user such that the user perceives the display light as an image. In addition, the first lens 108 and/or the second lens 110 are sufficiently transparent to allow a user to see through the lens elements to provide a FOV of the user's real-world environment such that the image appears superimposed over at least a portion of the real-world environment.

In some embodiments, each light engine 114 is a digital light processing-based projector, a microdisplay, scanning laser projector, or any combination of a modulative light source. For example, according to some embodiments, each light engine 114 includes a laser or one or more LEDs and a dynamic reflector mechanism such as one or more dynamic scanners or digital light processors. In some embodiments, each light engine 114 includes multiple laser diodes (e.g., a red laser diode, a green laser diode, and/or a blue laser diode) and at least one scan mirror (e.g., two one-dimensional scan mirrors, which may be MEMS-based or piezo-based). Each light engine 114 is communicatively coupled to the controller and a non-transitory processor-readable storage medium or a memory that stores processor-executable instructions and other data that, when executed by the controller, cause the controller to control the operation of each light engine 114. In some embodiments, the controller controls a scan area size and scan area location for each light engine 114 and is communicatively coupled to a processor (not shown) that generates content to be displayed at the display system 100. Each light engine 114 scans light over a variable area, designated the FOV area 106, of the display system 100. The scan area size corresponds to the size of the FOV area 106 and the scan area location corresponds to a region of the first lens 108 and/or the second lens 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

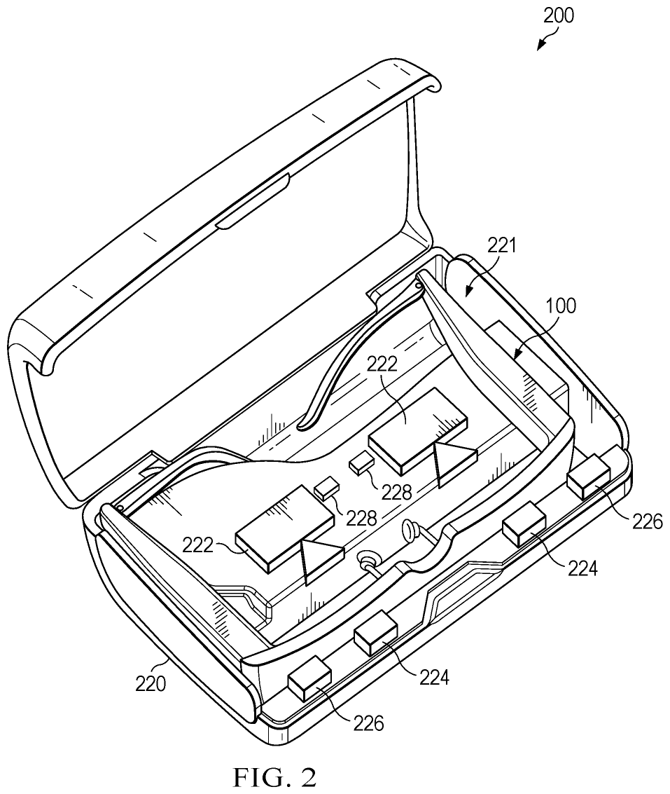

FIG. 2 illustrates a diagram of a deformation detection device 200 storing the display system 100 in accordance with some embodiments. The deformation detection device 200 is a device that generally receives and/or connects to the display system 100. It should be noted that while an example form factor is depicted, it will be appreciated that in other embodiments the deformation detection device 200 may have a different shape and appearance from the portable case depicted in FIG. 2. That is, in different embodiments, the deformation detection device 200 is a desktop stand, a desktop enclosure, or a clip-on device.

In various embodiments, the deformation detection device 200 includes a housing 220, a power source 221, a plurality of display alignment sensors 222, a plurality of angular position sensors 224, a plurality of camera reference modules 226, and a plurality of eye camera alignment sensors 228. Collectively, the plurality of display alignment sensors 222, the plurality of angular position sensors 224, the plurality of camera reference modules 226, and the plurality of eye camera alignment sensors 228 are also referred to as one or more sensors. The housing 220 is a container or a platform that receives and/or stores the display system 100. In other words, the housing 220 is used for storage of the display system 100 while not in use by a user. In some embodiments, the power source 221 includes a battery, a solar cell, a power connector (e.g., a cord and a plug), and any combination thereof, and the like. The power source 221 provides power to at least the display system 100 while the display system 100 is stored in the housing 220. Accordingly, the power source 221 charges the display system 100. In some embodiments, the power source 221 connects to the display system 100 using a wire and a connection interface (e.g., USB, USB-C). In different embodiments, the power source 221 charges the display system 100 through conductive charging and/or inductive charging.

In some embodiments, each of the plurality of alignment sensors 222 includes a an aperture for mechanical angle restriction, a lyot filter to limit input to a sensor photodiode (PD), a camera, a lens and positional sensitive detector (PSD), a pinhole and PSD, a lens and a complementary metal-oxide semiconductor (CMOS), a pinhole and CMOS, and any combination thereof. The plurality of alignment sensors 222 are configured to detect a display alignment level based on changes in images rendered on the display system 100 with respect to the original configuration. Specifically, the plurality of alignment sensors 222 detect the positional relationship of images projected from the display system 100 at a position where eyes of the user would receive the images and/or based on the side (i.e., left or right) of the display system 100 that is projecting the images. Furthermore, the plurality of alignment sensors 222 detect how the images are presented to the eyes, such as the image size, resolution, and/or other measures of quality. As such, the plurality of alignment sensors 222 detect a level of deformation based on deviation of the projected image with respect to the original configuration of the projected image.

The plurality of angular position sensors 224 are configured to detect an angular position level based on changes in position of each waveguide 116 from the original configuration with respect to an incoming beam of light projected from each of the plurality of angular position sensors 224. Specifically, the plurality of angular position sensors 224 detect the positional relationship of each waveguide 116 to determine an angle of direction for an incoming beam of light, such as from each light engine 114, and projected from the waveguide 116 toward the first lens 108 and/or the second lens 110 in response to moving through each waveguide 116. Moreover, the plurality of angular position sensors 224 detect how the images in each waveguide 116 is affected based on the angular position of each waveguide 116. As such, the plurality of angular position sensors 224 detect the level of deformation based on deviation of angular position of each waveguide 116 with respect to the original configuration that each waveguide 116 receives the incoming beam of light.

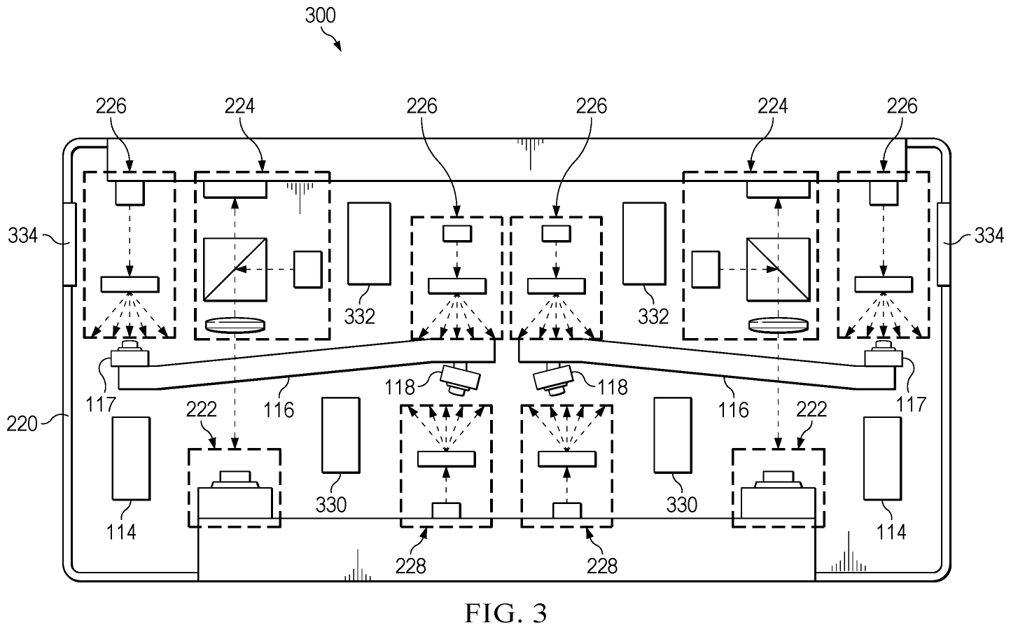

The plurality of camera reference modules 226 are configured to detect a first camera reference level based on changes in an environmental view rendered on the display system 100 with respect to the original configuration. Specifically, the plurality of camera reference modules 226 detect the positional relationship of the environmental view from world cameras 117 in FIG. 3 at one or more positions on the display system 100. The world cameras 117 receive environmental images (i.e., images captured by the world cameras 117) that are presented on the display to the user. For example, while using an AR application, the user walking in a basketball court while wearing the display system 100 would be presented with the basketball court based on the environmental images detected by the world cameras 117. As such, the plurality of camera reference modules 226 detect a level of deformation based on deviation of the world cameras 117 with respect to the original configuration of the world cameras 117.

The plurality of eye camera alignment sensors 228 are configured to detect a second camera reference level based on changes in each eye tracking camera 118 in FIG. 3 on the display system 100 with respect to the original configuration. Specifically, the plurality of eye camera alignment sensors 228 detect the positional relationship of the eye tracking cameras at one or more positions on the display system 100. The eye tracking cameras 118 track positions of the eyes of the user, such that a processing system of the display system 100 adjusts the display (e.g., the environmental view and/or images projected from the light engine 114) for the user. For example, while using the AR application, the eye tracking cameras 118 detect where pupils of the eyes are directed (i.e., looking) such that the images from the AR application appear consistent according to the direction the user is looking. As such, the plurality of eye camera alignment sensors 228 detect a level of deformation based on deviation of the eye tracking cameras 118 with respect to the original configuration of the eye tracking cameras 118.

FIG. 3 is a plan view of the deformation detection device 300 including a plurality of sensors and a plurality of calibration devices or calibration components. The deformation detection device 300 may implement or be implemented by aspects of the deformation detection device 200 as described with reference to FIG. 2. Similar to the deformation detection device 200, the deformation detection device 300 is a device that generally receives and/or connects to the display system 100. Furthermore, the deformation detection device 300 calibrates (i.e., corrects, adjusts, changes) the one or more components of the display system 100 based on the level of deformation detected by the one or more sensors. It will be appreciated that not all of the components of the display system 100 are always calibrated, as it depends on what the level of deformation is that is detected by the one or more sensors. In some embodiments, upon receipt of the display system 100, the deformation detection device 300 receives input of user-specific customization information. For example, the deformation detection device 300 receives input of head size of the user and interpupillary distance (IPD). Thus, the deformation detection device 300 and the plurality of calibration devices further calibrate based on the user-specific information to improve calibration results. In different embodiments, the deformation detection device 300 does not include the plurality of calibration devices, but instead stores data detected by the one or more sensors and transmits the data to an external device, such as a computing device, a smartphone, a tablet, a terminal, a calibration device, and/or any combination thereof, such that calibration is performed on the external device. Accordingly, to support determination of calibration and determine the level of deformation based on the data detected by the one or more sensors, the deformation detection device 300 includes one or more processor devices (e.g., a central processing unit (CPU), a graphics processing unit (GPU), an application-specific integrated circuit (ASIC)), one or more memory devices (e.g., a memory controller, a random-access memory (RAM), read-only memory (ROM), a flash drive, a hard drive), and one or more communication interfaces (e.g., cellular network, wireless network, Wi-Fi, Bluetooth), and the like.

In some embodiments, the deformation detection device 300 includes a plurality of display alignment calibration devices 330, a plurality of angular position calibration devices 332, and a plurality of camera calibration devices 334. Alternatively, in different embodiments, the plurality of calibration devices are a single device. The plurality of display alignment calibration devices 330 include circuitry to turn on single pixels of the light engine(s) and display them in the first lens 108 and/or the second lens 110 to check the display alignment level. The plurality of display alignment sensors 222 detect a response of the first lens 108 and/or the second lens 110. Additionally, an aperture size of the displays in the first lens 108 and/or the second lens 110 is adjusted, a size of a photodiode (i.e., light source within the light engine 114) is adjusted, angular size of the images on the first lens 108 and/or the second lens 110, and any combination thereof.

To illustrate via an example, after prolonged use by the user and exposure to the weather, the display in the first lens 108 and/or the second lens 110 have been subject to inelastic deformation (i.e., bending, warping, “aging”) such that the display viewed by the user is objectionable (i.e., blurred, misaligned, etc) and different than the original configuration. In response to placing the display system 100 in the deformation detection device 300, at least one of the plurality of display alignment sensors 222 detects the display has deviated (i.e., differs) from the original configuration due the display evincing a deviation in performance, and therefore, the display in the first lens 108 and/or the second lens 110 no longer provide the same clarity and/or alignment of the images. Accordingly, the plurality of display alignment calibration devices 330 adjust configuration of the display in the first lens 108 and/or the second lens 110, by changing display alignment and/or the pixel activation such that the display appears similar to the original configuration.

The plurality of angular position calibration devices 332 include circuitry to change position of output from each waveguide 116 based on the level of deformation. In other words, the output based on the deviation from the original configuration of the incoming beam of light from the light engine 114. The plurality of angular position calibration devices 332 adjust the pixels illuminated by the light engine 114, change angular position of the images on the first lens 108 and/or the second lens 110, and any combination thereof. To illustrate via an example, after prolonged use by the user and exposure to the weather, at least one of the waveguides 116 has been subject to inelastic deformation such that the incoming beam of light from the light engine 114 directs the light at an angle different than the original configuration. In response to storing the display system 100 in the deformation detection device 300, at least one of the plurality of angular position sensors 224 detects at least one of the waveguides 116 have deviated (i.e., differs) from the original configuration due the incoming beam of light reaching a different region of at least one of waveguides 116, and therefore, at least one of the waveguides 116 directs the light toward a different portion of the display in the first lens 108 and/or the second lens 110. Accordingly, the plurality of angular position calibration devices 332 adjust configuration of the image displayed by the waveguide 116, by changing the pixels illuminated by the light engine 114 or change angular size of the images on the first lens 108 and/or the second lens 110 such that the waveguide 116 directs light similar to the original configuration.

The plurality of camera calibration devices 334 include circuitry to change position of the world cameras 117 based on the level of deformation. In other words, the environmental images based on the deviation from the original configuration of the world cameras 117 are adjusted to provide a relatively pleasant viewing experience. The plurality of camera calibration devices 334 change the environmental images received by the world cameras 117 by adjusting the aperture size of the world cameras 117. To illustrate via an example, after prolonged use by the user and exposure to the weather, the world cameras 117 on the display system 100 change position such that the environmental view appears at an angle other than the original configuration. In response to storing the display system 100 in the deformation detection device 300, at least one of the plurality of camera reference modules 226 detects the environmental view has deviated (i.e., differs) from the original configuration due the environmental view having a different angle, and therefore, the position of the world cameras 117 have a different angle. Accordingly, the plurality of camera calibration devices 334 adjust configuration of the world cameras 117, by changing aperture size of the world cameras 117 such that the environmental view appears similar to the original configuration. Furthermore, in some embodiments, at least one of the plurality of calibration devices is used to calibrate the eye tracking cameras similar to any of the methods described above.

Thus, the deformation detection device 300 provides a portable and in-field solution to detect deformation of the display system 100 as well as calibrate the display system 100 based on the level of deformation. Furthermore, in some embodiments, the deformation detection device 300 is able to detect changes to the display system 100 in response to addition of prescription lenses to the display system 100. For example, in some cases, the user requires prescription lenses to view the environment and connects the prescription lenses to each waveguide 116. The one or more sensors of the deformation detection device 300 detect the changes from the original configuration as described above with respect to the one or more sensors.

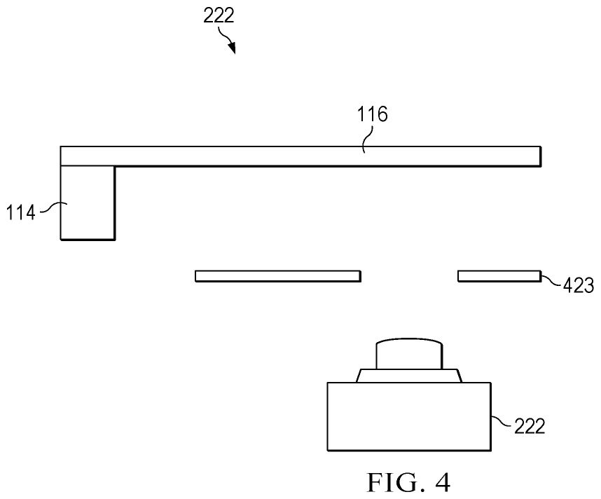

FIG. 4 illustrates a diagram of a display alignment sensor 222 in accordance with some embodiments. The display alignment sensor 222 may implement or be implemented by aspects of at least one of the plurality of display alignment sensors 222 as described with reference to FIGS. 2 and 3. In some embodiments, the display alignment sensor 222 includes an aperture 423. The aperture 423 adjusts an angle and/or a direction of the images directed from the waveguide 116 toward the display alignment sensor 222. Specifically, the display alignment sensor 222 detects the positional relationship of the images projected from the display system 100 at a position where the eyes of the user would receive the images and/or based on the side of the display system 100 that is projecting the images. To detect the positional relationship, the display alignment sensor 222 employs measurement of parameters including, for example, display geometry and left-to-right display alignment. In some embodiments, the display alignment sensor 222 detects the display geometry by detecting viewable image size (i.e., width and height on the display), aspect ratio, and radius of curvature (i.e., curvature on the display), and any combination thereof. In some embodiments, the display alignment sensor 222 detects the left-to-right display alignment by detecting arrangement of content on the display for the first lens 108 and/or the second lens 110. For example, the display alignment sensor 222 detects position of text through the aperture 423 as displayed from the first lens 108 to the second lens 110.

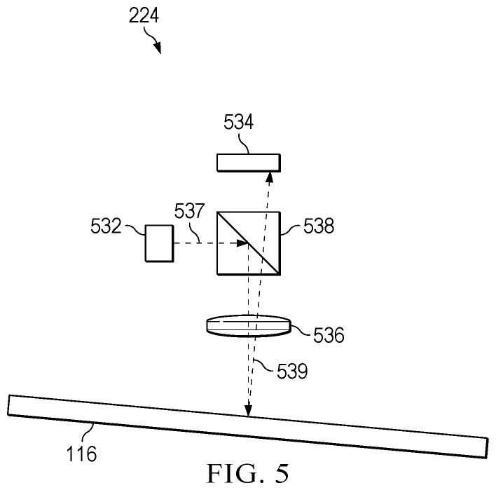

FIG. 5 illustrates a diagram of an angular position sensor 224 in accordance with some embodiments. The angular position sensor 224 may implement or be implemented by aspects of at least one of the plurality of angular position sensors 224 as described with reference to FIGS. 2 and 3. In some embodiments, the angular position sensor 224 includes a light source 532, a position sensor 534, a collimating lens 536, and a beamsplitter 538. In different embodiments, the light source 532 includes a light-emitting diode (LED) source, a laser source, a backlit reticle source, a fiber coupled LED source, and a fiber coupled laser source. Additionally, in different embodiments, the position sensor 534 includes a CMOS sensor, a quadrant PD, and a PSD. In the depicted example, the light source 532 projects a first beam of light 537 toward the beamsplitter 538. The beamsplitter 538 splits the first beam of light 537, such that a second beam of light 539 is directed through the collimated lens 536 to the waveguide 116 and subsequently reflected off the waveguide 116 at an angle toward the position sensor 534. In this manner, the position sensor 534 detects the angle the second beam of light 539 is received. As such, the position sensor 534 detects the level of deformation based on the angle of the second beam of light 539 received by the position sensor 534. For example, the position sensor 534 detects and/or measures a pitch and a yaw of the waveguide 116 based on the angle of the second beam of light 530 with respect to a coordinate system. Moreover, the pitch and the yaw of the waveguide 116 is measured with respect to the original configuration within the display system 100. It will be appreciated that in different embodiments, the angular position sensor 224 excludes the beamsplitter 538, the collimated lens 536, or both. In this case, the light source 532 and the position sensor 534 are placed at predetermined angles with respect to each other in order to measure the pitch and the yaw of the beam of light reflected from the waveguide 116. In different embodiments, the collimated lens 536 is replaced with a pinhole. Furthermore, in different embodiments, there may be a plurality of the position sensors 534.

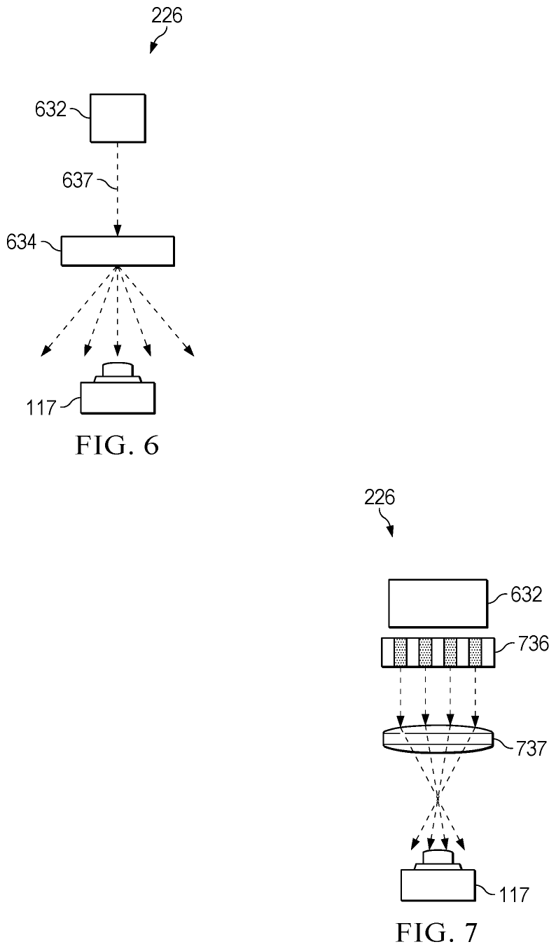

FIG. 6 illustrates a diagram of a camera reference module 226 using a diffractive grating 634 in accordance with some embodiments. The camera reference module 226 may implement or be implemented by aspects of at least one of the plurality of camera reference modules 226 as described with reference to FIGS. 2 and 3. In some embodiments, the camera reference module 226 includes a light source 632 and a diffractive grating 634. In different embodiments, the light source 632 includes a visible light source, a near-infrared (NIR) source, a vertical cavity surface emitting laser (VCSEL), a collimated Fabry-Pérot (FP) laser, a collimated edge emitting laser (EEL), an LED, and any other collimated light source. Additionally, in different embodiments, the diffractive grating 634 includes a volume phase holographic grating, a computer-generated hologram (CGH), a polymer dispersed liquid crystal grating, and a surface relief grating (SRG). In the depicted example, the light source 632 projects a beam of light 637 toward the diffractive grating 634. The diffractive grating 634 diffracts the beam of light 637 into multiple portions with each portion angled in a different direction toward the world camera 117. Stated differently, the diffractive grating 634 generates a fan of collimated light (i.e., the multiple portions of the beam of light 637) at regular angle intervals. In response to projecting the fan of collimated light on the world camera 117, each portion of the collimated light is used as a grid of points to determine the spacing of each portion, which measures both intrinsic parameters (i.e., focal length, field of view, aperture, resolution) and extrinsic parameters (i.e., location, orientation) of the world camera 117. As such, based on the spacing of the portions of the beam of light 637 on the world camera 117, at least one of the plurality of camera calibration devices 334 is used to adjust the world camera 117, such as adjusting the aperture size of the world camera 117.

FIG. 7 illustrates a diagram of a camera reference module 226 using pinholes 736 in accordance with some embodiments. The camera reference module 226 may implement or be implemented by aspects of at least one of the plurality of camera reference modules 226 as described with reference to FIGS. 2, 3, and 6. In some embodiments, the camera reference module 226 includes the light source 632, pinholes 736, and a collimated lens 737. In contrast to the operation of the camera reference module 226 in FIG. 6, in the depicted example of FIG. 7, the pinholes 632 receive light from the light source 632 and direct the light to the collimated lens 737. The collimated lens 737 generates a fan of light used as a grid of points to determine the spacing of each portion as described above with reference to FIG. 6.

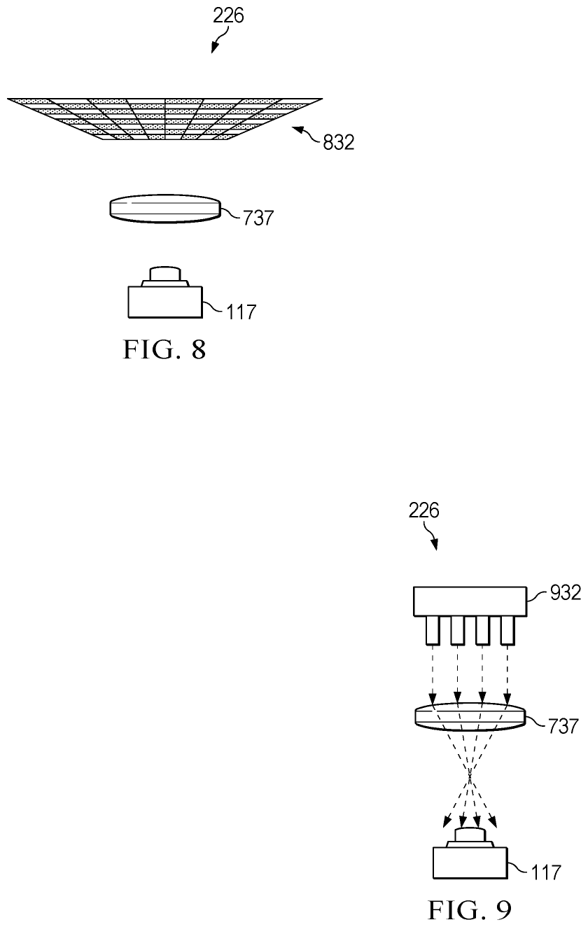

FIG. 8 illustrates a diagram of a camera reference module 226 using a microchart 832 in accordance with some embodiments. The camera reference module 226 may implement or be implemented by aspects of at least one of the plurality of camera reference modules 226 as described with reference to FIGS. 2, 3, 6, and 7. In some embodiments, the camera reference module 226 includes the microchart 832 and the collimated lens 737. In contrast to the operation of the camera reference module 226 in FIGS. 6 and 7, in the depicted example of FIG. 8, the microchart 832 provides mapping between a camera pixel on the world camera 117 and the angle of the world camera 117.

FIG. 9 illustrates a diagram of a camera reference module 226 using a laser array 932 in accordance with some embodiments. The camera reference module 226 may implement or be implemented by aspects of at least one of the plurality of camera reference modules 226 as described with reference to FIGS. 2, 3, 6, 7, and 8. In some embodiments, the camera reference module 226 includes the laser array 932 and the collimated lens 737. In contrast to the operation of the camera reference module 226 in FIGS. 6, 7, and 8, in the depicted example of FIG. 8, the laser array 932 projects a plurality of beams of light to the collimated lens 737. In other words, the collimated lens 737 receives a plurality of beams of light similar to the collimated lens 737 in FIG. 7. Accordingly, the collimated lens 737 generates a fan of light used as a grid of points to determine the spacing of each portion as described above with reference to FIG. 6.

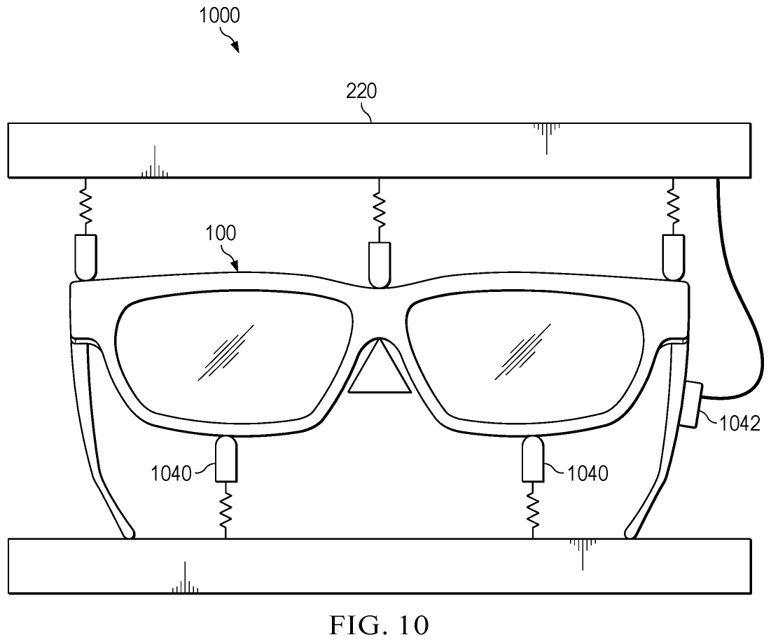

FIG. 10 illustrates a diagram of a mechanical transducer 1000 in accordance with some embodiments. The mechanical transducer 1000 may be implemented in the deformation detection device 200 as described with reference to FIG. 2 or the deformation detection device 300 as described with reference to FIG. 3. Thus, in different embodiments, the mechanical transducer 1000 is integrated and disposed in the deformation detection device 200 or the deformation detection device 300, such as on the housing 220.

In some embodiments, the mechanical transducer 1000 includes a plurality of mechanical fingers 1040 and a charger 1042. In the depicted example, each of the plurality of mechanical fingers 1040 are connected to the housing 220. Additionally, the plurality of mechanical fingers 1040 receive the display system 100 therein to detect a position of the display system 100 within the housing 220. Moreover, the plurality of mechanical fingers 1040 detect the position of the display system 100 to determine orientation within the housing 220 prior to using the one or more sensors. Thus, the plurality of fingers 1040 identify a baseline alignment of the display system 100 is measured, such that subsequent detection of the level of deformation, if any, is based on actual deviation from the original configuration of the display system 100 and not based on a physical position of the display system 100 within the housing 220. Accordingly, the deformation detection device 300 indicates physical adjustment (i.e., rearrangement) in response to any misalignment detected by the plurality of mechanical fingers 1040. In different embodiments, the mechanical transducer 1000 includes an autocollimator that detects a position of each waveguide 116 to adjust the calibration to the display in the first lens 108 and/or the second lens 110, and the world cameras 117. Moreover, in different embodiments, the plurality of mechanical fingers 1040 detect supplemental information of the level of deformation of the display system 100. In different embodiments, the mechanical transducer 1000 includes mechanical datums to receive the display system 100 and/or display cameras that determine how the display system 100 is stored in the housing 220. In different embodiments, the mechanical transducer 1000 includes thermocouples disposed at one or more portions of the housing 220 to transduce one or more temperature levels of the display system 100.

Alternatively, and/or in addition thereto, in different embodiments, the plurality of mechanical fingers 1040 apply a predetermined level of force to simulate the level of deformation based on a head-size of the user and/or interpupillary distance (IPD) of the user. In other words, the plurality of mechanical fingers 1040 simulate an “as-worn” position, as if the user were wearing the display system 100. For example, the plurality of mechanical fingers 1040 move the display system 100 within the deformation detection device 300 based on the head size received as input from an external device, such as a camera, a smartphone, a desktop computer, and the like.

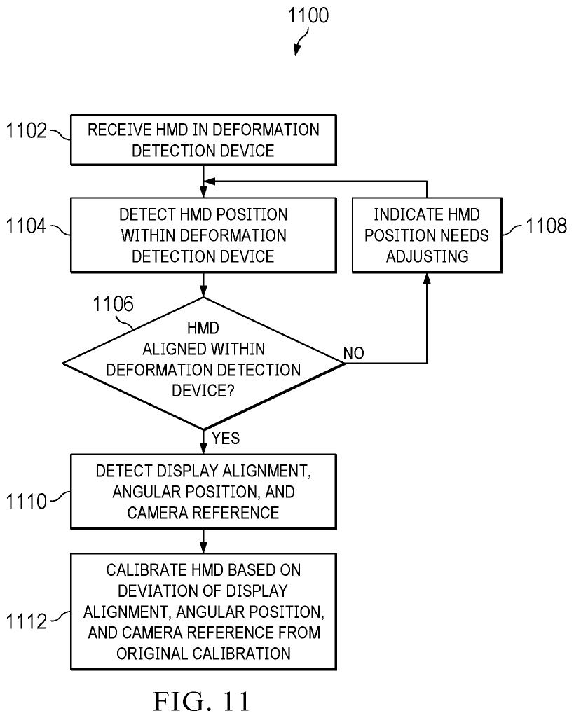

FIG. 11 illustrates a flow diagram illustrating a method 1100 for detecting deformation in the display system 100 in accordance with some embodiments. The method 1100 is described with respect to an example implementation of the deformation detection device 300 of FIG. 3. At block 1102, the deformation detection device 300 receives and connects to the display system 100. At block 1104, the mechanical transducer 1000 detects the position of the display system 100. Specifically, the plurality of mechanical fingers 1040 detect the position of the display system 100 to determine orientation within the housing 220 prior to using the one or more sensors of the deformation detection device 300.

At block 1106, the plurality of fingers 1040 determine whether the display system 100 is properly aligned within the housing 220. At block 1108, the display system 100 is not properly aligned within the housing 220 and the deformation detection device 300 indicates physical adjustment to the display system 100 based on misalignment and the process returns to block 1104 to check the position of the display system 100. At block 1110, the plurality of mechanical fingers 1040 determine the display system 100 is properly aligned in the housing 220. Therefore, the plurality of alignment sensors 222 detect the positional relationship of the images projected from the display system 100 at a position where eyes of the user would receive the images and/or based on the side of the display system 100 that is projecting the images. Additionally, the plurality of angular position sensors 224 detect the positional relationship of each waveguide 116 to determine an angle of direction for an incoming beam of light, such as from each light engine 114, and projected from the waveguide 116 toward the first lens 108 and/or the second lens 110 in response to moving through each waveguide 116. Moreover, the plurality of camera reference modules 226 detect the positional relationship of the environmental view from world cameras 117 at one or more positions on the display system 100.

At block 1112, the deformation detection device 300 calibrates the display system 100 based on results detected by the one or more sensors. For example, the plurality of display alignment calibration devices 330 adjust the aperture size of the displays in the first lens 108 and/or the second lens 110, adjust the size of the photodiode, adjust the angular size of the images on the first lens 108 and/or the second lens 110, and any combination thereof. Alternatively, and/or in addition thereto, the plurality of angular position calibration devices 332 adjust the direction of the beam of light from the light engine 114, change angular size of the images on the first lens 108 and/or the second lens 110, and any combination thereof. Alternatively, and/or in addition thereto, the plurality of camera calibration devices 334 adjusts the world camera 117, such as adjusting the aperture size of the world camera 117.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A deformation detection device, comprising:
a housing configured to receive and charge a battery of a head-mounted display (HMD);
at least one display alignment sensor configured to detect a display alignment level of a display of the HMD;
at least one angular position sensor configured to detect an angular position level of a waveguide within the HMD;
at least one camera reference module configured to detect a first camera reference level of a world camera on the HMD; and
a plurality of calibration devices integrated within the housing and configured to calibrate at least one of the display, the waveguide, and the world camera based on the display alignment level, the angular position level, and the first camera reference level.

2. The deformation detection device of claim 1, wherein the at least one display alignment sensor is further configured to: detect at least one of display geometry and left to right display alignment.

3. The deformation detection device of claim 1, wherein the at least one angular position sensor is further configured to:
detect pitch and yaw of the waveguide with respect to an incoming beam of light.

4. The deformation detection device of claim 1, wherein the plurality of calibration devices are further configured to:
calibrate based on deviation of at least one of the display, the waveguide, and the world camera from an original configuration corresponding to the display, the waveguide, and the world camera.

5. The deformation detection device of claim 1, wherein the at least one camera reference module is further configured to:
detect light received on the world camera; and
determine at least one of intrinsic parameters and extrinsic parameters based on spacing of the light.

6. The deformation detection device of claim 5, wherein the light is received through a diffractive grating.

7. The deformation detection device of claim 5, wherein the light is received through a microchart.

8. The deformation detection device of claim 1, further comprising:
at least one eye camera alignment sensor configured to detect a second camera reference level of an eye tracking camera on the HMD; and
at least one of the plurality of calibration devices is further configured to calibrate the eye tracking camera based on the second camera reference level.

9. The deformation detection device of claim 1, wherein the plurality of calibration devices are further configured to:
adjust a calibration of at least one of the display, the waveguide, and the world camera in response to detecting a prescription lens on the HMD.

10. The deformation detection device of claim 1, further comprising:
a mechanical transducer configured to detect a position of the HMD within the deformation detection device.
